(19) United States
(12) Patent Application Publication
(10) Pub. No.: US 2011/0151847 A1
(43) Pub. Date: Jun. 23, 2011

(54) CONTENTS PROVIDING APPARATUS AND METHOD

(75) Inventors: Jae-ho Kim, Daejeon (KR); Sang Ho Lee, Daejeon (KR); Jai Hyung Cho, Daejeon (KR); Eun Hee Hyun, Daejeon (KR)

(73) Assignee: Electronics and Telecommunications Research Institute, Daejeon (KR)

(21) Appl. No.: 13/058,732

(22) PCT Filed: Dec. 31, 2008
(86) PCT No.: PCT/KR2008/007832

§ 371 Date: Feb. 11, 2011

(30) Foreign Application Priority Data
Aug. 13, 2008 (KR) 10-2008-0079338

(51) Int. Cl. H04W 4/02

(52) U.S. Cl. 455/414.2

(57) ABSTRACT

A contents providing apparatus and method is provided. A contents providing apparatus based on a mobile communication network, the contents providing apparatus including: a receiving unit receiving contents and contents providing area information of the contents from a contents provider, the contents providing area information being information about an area where the contents is provided; an area group setting unit retrieving at least one cell based on the contents providing area information, and setting the retrieved at least one cell as a contents providing area group of the contents; and a transmitting unit transmitting the contents to the set contents providing area group.

### TECHNICAL FIELD

The present invention relates to contents providing apparatus and method, and more particularly, to an apparatus and method of providing contents based on information about an area where contents is to be provided.

This work was supported by the IT R&D of MIC/IITA. [2008-S-006-01, Development of Open-IPTV (IPTV2.0) Technologies for Wired and Wireless Networks].

### BACKGROUND ART

Currently, mobile terminals (portable devices) come into wide use due to development of mobile communication, and most people have a mobile terminal such as a cellular phone, Personal Digital Assistant (PDA), and the like.

Along with the development of communication technologies and increase in users, mobile terminals may provide a basic service such as a voice call and Short Message Service (SMS) as well as a variety of services such as a video replay, advertising, navigation, accident/disaster information providing, and the like.

The 3^{rd} Generation Partnership Project (3GPP) release 7 provides a mechanism for providing a mobile location service. The mechanism mainly defines a method of measuring a terminal location based on an intensity of a signal received in a base station in a network, a structure and function of the network for converting and transmitting measured location information, and protocols. Various location-based services such as navigation, positioning, surrounding information search, safety, rescue, and advertising may be provided in a mobile communication network. Such services are generally a unicasting-based service, excluding broadcasting services such as a disaster relief-related broadcasting.

Also, the 3GPP standardizes a Multimedia Broadcast and Multicast Service (MBMS) using a broadcasting/multicast technology to efficiently provide users with massive multimedia contents.

### DISCLOSURE OF INVENTION

### Technical Problem

The present invention provides a contents providing an apparatus and method which simultaneously transmits a message to a plurality of cells, and thereby may reduce a waste of network resources due to redundant transmission of data.

The present invention also provides a contents providing apparatus and method which may selectively transmit contents associated with a particular area to a content user located in the area.

### Technical Solution

According to an aspect of the present invention, there is provided a contents providing apparatus based on a mobile communication network, the contents providing apparatus including: a receiving unit receiving contents and contents providing area information of the contents from a contents provider, the contents providing area information being information about an area where the contents is provided; an area group setting unit retrieving at least one cell based on the contents providing area information, and setting the retrieved at least one cell as a contents providing area group of the contents; and a transmitting unit transmitting the contents to the set contents providing area group.

According to another aspect of the present invention, there is provided a contents providing method based on a mobile communication network, the contents providing method including: receiving contents and contents providing area information of the contents from a contents provider, the contents providing area information being information about an area where the contents is provided; retrieving at least one cell based on the contents providing area information, and setting the retrieved at least one cell as a contents providing area group of the contents; and transmitting the contents to the set contents providing area group.

### BRIEF DESCRIPTION OF THE DRAWINGS

FIG. 1 is a diagram illustrating a configuration of a network including a contents providing apparatus according to an embodiment of the present invention;

FIG. 2 is a block diagram illustrating a configuration of a contents providing apparatus according to an embodiment of the present invention;

FIG. 3 is a flowchart illustrating operations of a contents providing apparatus according to an embodiment of the present invention; and

FIG. 4 is a flowchart illustrating a method of providing contents according to an embodiment of the present invention.

### MODE FOR THE INVENTION

Hereinafter, embodiments of the present invention are described in detail by referring to the figures.

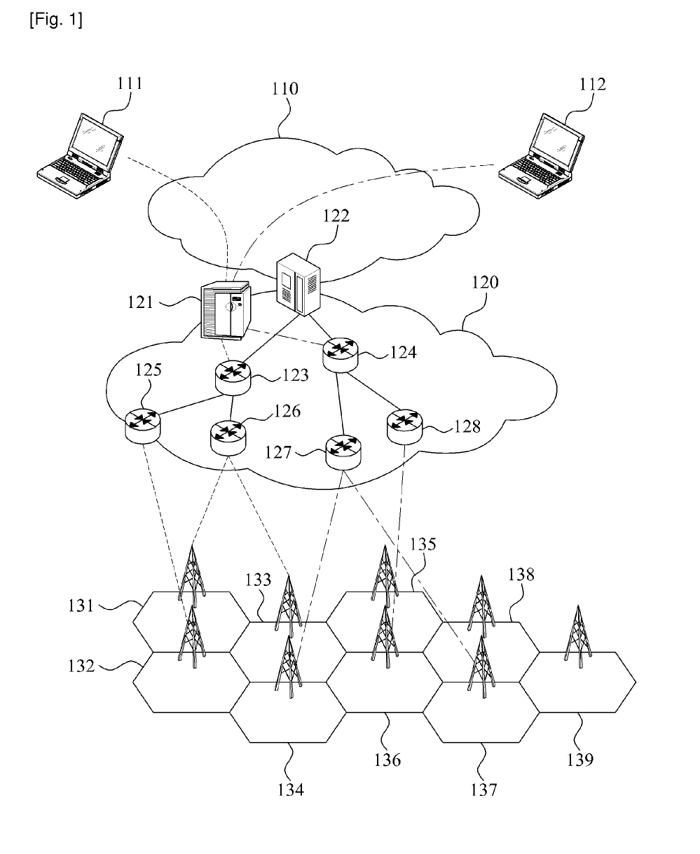

FIG. 1 is a diagram illustrating a configuration of a network including a contents providing apparatus according to an embodiment of the present invention. Hereinafter, embodiments of the present invention are described in detail with reference to FIG. 1.

Referring to FIG. 1, contents providers 111 and 112 transmit data to a content providing apparatus 121 through a public Internet Protocol (IP) network 110.

According to an embodiment of the present invention, the data transmitted by the contents providers 111 and 112 may include contents and contents providing area information of the contents. The contents providing area information is information about an area where the contents is provided. The contents providers 111 and 112 may transmit the contents and the information about the area to the contents providing apparatus 121 simultaneously or separately.

For example, when the contents providers 111 and 112 are a person who sells school supplies, since the contents providers 111 and 112 desire to advertise school supplies in only an area including a school, the contents providing area information may include a name of the school, a range of area for an advertisement (for example, within 1 km around XX school), and the like, and the contents may include advertisement information about the school supplies. As described above, when the contents providing area information associated with the limited area range is transmitted, the contents is transmitted to mobile terminals located within the limited area. Accordingly, content users having the mobile terminals may receive the advertisement service.

The public IP network 110 used by the contents providers 111 and 112 for data transmission and a mobile communication network 120 used to provide the contents may be different. According to an embodiment of the present invention, the contents providers 111 and 112 may access the mobile communication network 120 through a gateway 122. The gateway 122 may be software or hardware enabling networks with different protocols to communicate, and function as a path among different networks.

The content providing apparatus 121 receiving the contents providing area information from the contents providers 111 and 112 retrieves a cell included in the contents providing area based on the contents providing area information. Since the mobile communication network 120 is a cell-based structure, a cell coverage-based positioning may be performed. Accordingly, the contents providing apparatus 121 may retrieve cells 131, 132, 133, 134, 136, and 137 which are located in the contents providing area limited by the contents providers 111 and 112.

When the cells are retrieved, the contents providing apparatus 121 sets a contents providing area group including the retrieved cells. As illustrated in FIG. 1, with respect to the content provider 111, the contents providing apparatus 121 retrieves the cells 131, 132, and 133, and generates a contents providing area group including the retrieved cells 131, 132, and 133. Also, with respect to the content provider 112, the contents providing apparatus 121 retrieves the cells 134, 136, and 137, and generates a contents providing area group including the retrieved cells 134, 136, and 137. The contents providing apparatus 121 transmits the contents received from the contents providers 111 and 112 to the contents providing area groups.

To transmit the contents to the contents providing area groups, the contents providing apparatus 121 generates a contents transmission path through a plurality of routers 123 through 128. The plurality of routers 123 through 128 is included in the mobile communication network 120. A router is a device for connecting separated networks that use a same communication network or same transmission protocol, and connects network layers. Accordingly, when the contents provider 111 transmits the contents to the cells 131, 132, and 133, the contents providing apparatus 121 generates a contents transmission path using the routers 123, 125, and 126, and transmits the contents through the contents transmission path. Similarly, when the contents provider 112 transmits the contents to the cells 134, 136, and 137, the contents providing apparatus 121 generates a contents transmission path using the routers 124, 127, and 128, and transmits the contents through the contents transmission path.

According to an embodiment of the present invention, the contents providing apparatus 121 transmits the contents to the cells included in the contents providing area group through the contents transmission path, and thereby may selectively provide contents users, located in a particular area, with contents highly associated with the particular area. Also, contents users having a mobile terminal may select and receive contents from contents providers that provide the contents with respect to a particular area where the contents users are located.

The contents providing apparatus 121 simultaneously transmits a message to a plurality of cells included in the contents providing area group, and thereby may reduce a waste of network resources due to a redundant transmission of data.

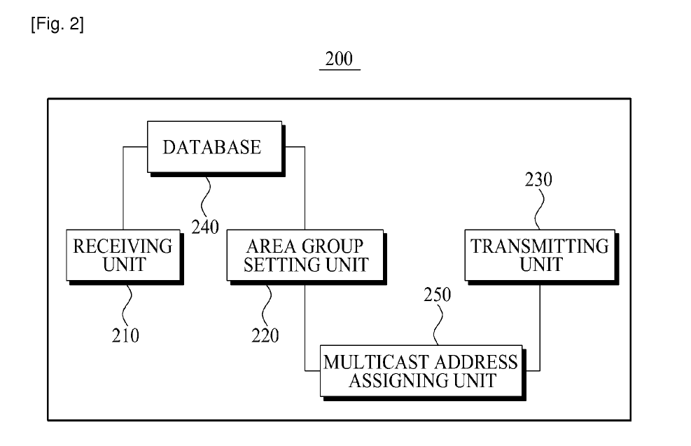

FIG. 2 is a block diagram illustrating a configuration of a contents providing apparatus 200 according to an embodiment of the present invention.

According to an embodiment of the present invention, the contents providing apparatus 200 includes a receiving unit 210, area group setting unit 220, and transmitting unit 230. According to an embodiment of the present invention, the contents providing apparatus 200 may further include a database 240, and a multicast address assigning unit 250. Hereinafter, the contents providing apparatus 200 is described in detail.

The receiving unit 210 receives contents and contents providing area information of the contents from a contents provider.

The contents provider may be an advertiser that desires to advertise a contents providing area, or a provider that provides a public service associated with the contents providing area. According to an embodiment of the present invention, the contents provided from the contents provider may include information about at least one of traffic, weather, disaster, accident, and advertisement associated with the contents providing area where the contents is provided.

As described above, the receiving unit 210 may receive contents including advertisement information from the contents provider that desires to advertise the contents providing area. Also, the receiving unit 210 may receive contents including public service information such as traffic, weather, disaster, and accident information from the contents provider that provides the public service associated with the contents providing area. The disaster information is information associated with an accident of a natural hazard such as windstorm, flooding, hurricane, tsunami, heavy snow, drought, earthquake, and the like. The accident information is information associated with an accident of a man-made hazard such as fire, collapse of a structure, explosion, traffic accident, environmental pollution, and chemical, biological, and radiological accident, which affect life and properties of human.

According to an embodiment of the present invention, the contents providing area information may include at least one of a geographical name, administrative name, facility name, landmark, and longitude/latitude coordinates.

The geographical name is a name of a region, mountains and rivers, and a city enabling land to be distinguished. The administrative name is a name of administrative unit for dividing a country, which is politically a single nation, according to an administrative purpose. The facility name is a name of facilities located in a particular area. For example, the facility name may include a school name and a name of building that is located in a particular area and represents the particular area. The landmark is a name of an easily recognizable object that may be used to identify a particular area.

The area group setting unit 220 retrieves at least one cell based on the contents providing area information, and sets the retrieved at least one cell as a contents providing area group of the contents.

A cell indicates an area covered by a single mobile communication base station. A size of the cell is determined by output power, a number of subscribers of a corresponding area, a number of used channels, and the like. Since the contents provider may desire to transmit the contents to an area included in a single cell as well as an area included in a plurality of cells, the contents providing area may include a plurality of cells. Accordingly, the area group setting unit 220 retrieves the at least one cell. Also, the area group setting unit 220 sets the contents providing area group using the retrieved at least one cell.

The transmitting unit 230 transmits the received contents to the contents providing area group set in the area group setting unit 220.

As described above, according to an embodiment of the present invention, the contents providing apparatus 200 may further include the database 240.

The database 240 stores at least one contents providing area group. When a contents providing area group corresponding to the contents providing area information, received by the receiving unit 210, is stored in the database 240, the area group setting unit 220 may set the stored contents providing area group as a contents providing area group of the received contents.

When the receiving unit 210 receives contents providing area information from an existing contents provider, and the area group setting unit 220 retrieves a cell based on the contents providing area information, received from the existing contents provider, and sets the retrieved cell as a contents providing area group, the database 240 stores the previously set contents providing area group.

When contents providers different from each other desire to provide contents to a same area, since the previously set contents providing area group is stored and contents is transmitted using the stored contents providing area group, time and resources used to retrieve a cell may be reduced.

That is, when the contents providing area information is received from the contents provider, the area group setting unit 220 determines whether the contents providing area group corresponding to the received contents providing area information is stored in the database 240. When the contents providing area group corresponding to the received contents providing area information is stored in the database 240, the area group setting unit 220 does not retrieve a cell based on the received contents providing area information, and sets the stored contents providing area group as a contents providing area group.

As described above, according to an embodiment of the present invention, the contents providing apparatus 200 may further include the multicast address assigning unit 250.

In this instance, the multicast address assigning unit 250 assigns a multicast group address to the contents providing area group, set in the area group setting unit 240, and sets a multicast group. The transmitting unit 230 may set a multicast tree with respect to at least one cell of the multicast group and transmit the contents based on the multicast tree. That is, the contents providing apparatus 200 may transmit the contents to the contents providing area group using a multicast transmission scheme.

In the multicast transmission scheme, at least one transmitter transmits data to a plurality of particular receivers. The multicast transmission scheme is different from a unicast transmission scheme or broadcast transmission scheme. In the unicast transmission scheme, a single transmitter transmits data to a single receiver, and in the broadcast transmission scheme, at least one transmitter transmits data to unspecified receivers.

When the contents is transmitted using the multicast transmission scheme, the transmitting unit 230 may simultaneously transmit the contents to the at least one cell of the multicast group. Accordingly, a waste of network resources due to redundant transmission of data may be reduced. The transmitting unit 230 may generate the multicast tree with respect to each of the at least one cell of the multicast group and transmit the contents to the multicast tree.

According to an embodiment of the present invention, the transmitting unit 230 may request the at least one cell of the multicast group to participate in the multicast group. Also, the transmitting unit 230 may set the multicast tree with respect to the at least one cell having participated in the multicast group according to the request.

Specifically, the transmitting unit 230 does not generate the multicast tree with respect to all of the at least one cell of the multicast group, and first requests the at least one cell to participate in the multicast group. When having participated, the transmitting unit 230 generates the multicast tree with respect to only cells having participated, and transmits the contents.

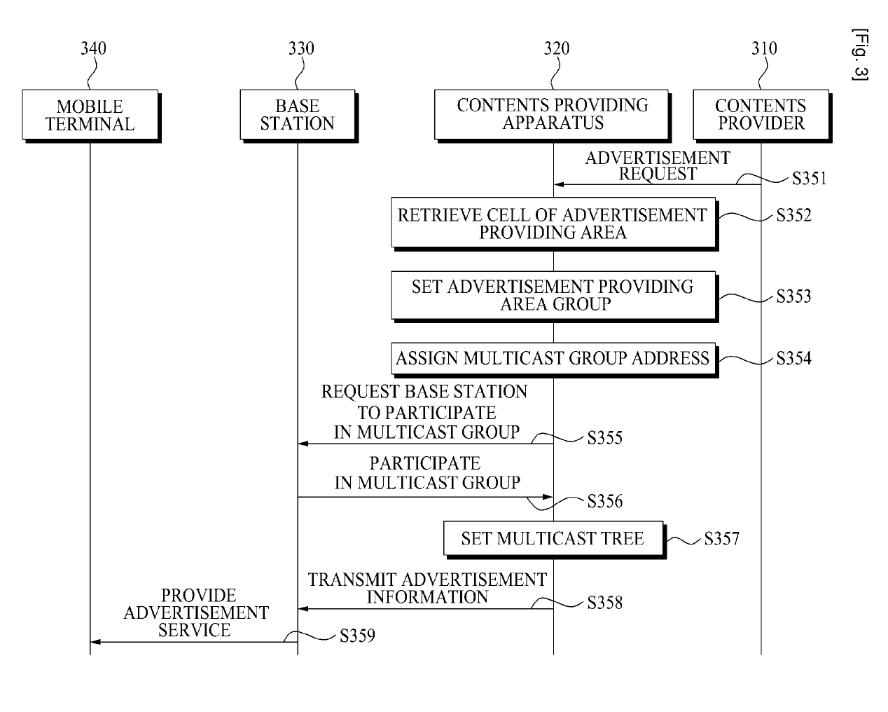

FIG. 3 is a flowchart illustrating operations of a contents providing apparatus according to an embodiment of the present invention.

In FIG. 3, it is assumed that a contents provider 310 is a region-based advertisement information provider, and a contents providing apparatus 320 transmits advertisement information based on a multicast transmission scheme. Hereinafter, operations of the contents providing apparatus 320 are described in detail with reference to FIG. 3.

In operation S351, the contents provider 310 requests the contents providing apparatus 320 for an advertisement. When making a request, the contents provider 310 transmits advertisement information to be transmitted and information about an advertisement providing area to be provided with an advertisement, to the contents providing apparatus 320.

In operation S352, the contents providing apparatus 320 retrieves at least one cell included in the advertisement providing area.

In operation S353, the contents providing apparatus 320 sets an advertisement providing area group based on the at least one cell retrieved in operation S352. In operation S354, the contents providing apparatus 320 assigns a multicast group address to the advertisement providing area group and sets a multicast group.

In operation S355, the contents providing apparatus 320 requests a base station 330 to participate in the multicast group. The base station 330 manages cells in the multicast group.

In operation S356, the base station 330 receiving the request notifies participation in the multicast group to the contents providing apparatus 320 and participates in the multicast group.

In operation S357, the contents providing apparatus 320 receiving the notice from the base station 330 sets a multicast tree with respect to at least one cell of the multicast group.

In operation S358, the contents providing apparatus 320 transmits the advertisement information to the base station 330 based on the multicast tree.

In operation S359, the base station 330 receiving the advertisement information provides an advertisement service to a mobile terminal 340 located in a cell managed by the base station 330.

According to an embodiment of the present invention, the base station 330 may provide the advertisement service to only mobile terminal 340 that definitely requests whether to receive the advertisement service (whether to receive contents).

According to another embodiment of the present invention, when whether to receive the advertisement service (whether to receive contents) is not requested, the base station 330 may provide the advertisement service to all the mobile terminals 340 located in the cell managed by the base station 330.

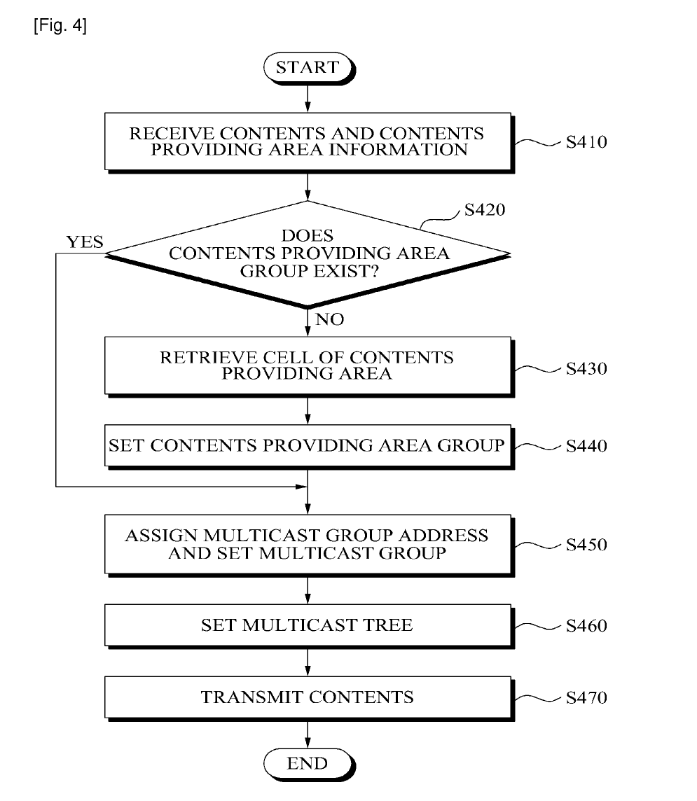

FIG. 4 is a flowchart illustrating a contents providing method according to an embodiment of the present invention. Hereinafter, the contents providing method is described in detail with reference to FIG. 4.

In operation S410, contents and contents providing area information of the contents is received from a contents provider. The contents provider may be a region-based advertisement service provider or public service provider. According to an embodiment of the present invention, the contents provided from the contents provider may include information about at least one of traffic, weather, disaster, accident, and advertisement associated with the contents providing area where the contents is provided.

According to an embodiment of the present invention, the contents providing area information may include at least one of a geographical name, administrative name, facility name, landmark, and longitude/latitude coordinates.

In operation S420, it is determined whether a contents providing area group corresponding to the received contents providing area information exists.

Specifically, according to an embodiment of the present invention, when the contents provider transmits the contents to a particular contents providing area group using the contents providing method, the contents providing area group receiving the contents may be stored. That is, in this instance, when a previous contents provider transmits the contents to a contents providing area group based on the contents providing method, the contents providing area group associated with the previous contents provider is stored. In operation S420, it is determined whether the contents providing area group corresponding to the contents providing area received in operation S410 is stored.

In operation S430, when the contents providing area group corresponding to the received contents providing area information does not exist, a cell included in the contents providing area is retrieved based on the contents providing area information received in operation S410. The cell included in the contents providing area may be at least one cell.

In operation S440, the retrieved at least one cell is set as a contents providing area group of the received contents. According to an embodiment of the present invention, the contents providing area group set in operation S440 may be stored.

When the contents providing area group corresponding to the received contents providing area information exists, the previously stored contents providing area group may be set as a contents providing area group of the contents received in operation S410, in operation S420. In this instance, the retrieving in operation S430 and the setting in operation S440 may not be performed.

In operation S450, a multicast group address is assigned to the contents providing area group set in operation S440, and a multicast group is set.

When the contents is transmitted using a multicast transmission scheme, in operation

S470, the contents may be simultaneously transmitted to at least one cell of the multicast group. Accordingly, a waste of network resources due to redundant transmission of data may be reduced.

In operation S460, a multicast tree is generated with respect to each of the at least one cell of the multicast group, and the contents is transmitted to the multicast tree.

According to an embodiment of the present invention, in operation S460, the at least one cell of the multicast group may be requested to participate in the multicast group, and the multicast tree may be set with respect to the cells having participated in the multicast group.

That is, in operation S460, the multicast tree is not generated with respect to all of the at least one cell of the multicast group, and the request for the participation in the multicast group is first made with respect to corresponding cells. The multicast tree is generated with respect to only cells having participated, and the contents may be transmitted.

The contents providing method has been described and illustrated in FIG. 4. Descriptions that are not described herein may be applied to the descriptions described with reference to FIGS. 1 through 3. Accordingly, a detailed description is omitted.

The above-described embodiment of the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM disks and DVD; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

According to an embodiment of the present invention, a contents providing apparatus and method simultaneously transmits a message to a plurality of cells, and thereby may reduce a waste of network resources due to redundant transmission of data.

Also, according to an embodiment of the present invention, a contents providing apparatus and method may selectively transmit contents associated with a particular area to a content user located in the area.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. A contents providing apparatus based on a mobile communication network, the contents providing apparatus comprising:
a receiving unit receiving contents and contents providing area information of the contents from a contents provider, the contents providing area information being information about an area where the contents is provided;
an area group setting unit retrieving at least one cell based on the contents providing area information, and setting the retrieved at least one cell as a contents providing area group of the contents; and
a transmitting unit transmitting the contents to the set contents providing area group.

2. The contents providing apparatus of claim 1, wherein the contents includes information about at least one of traffic, weather, disaster, accident, and advertisement associated with the area where the contents is provided.

3. The contents providing apparatus of claim 1, wherein the contents providing area information includes at least one of a geographical name, administrative name, facility name, landmark, and longitude/latitude coordinates.

4. The contents providing apparatus of claim 1, further comprising:
a database storing at least one contents providing area group,
wherein the area group setting unit sets a contents providing area group corresponding to the received contents providing area information as a contents providing area group of the received contents, when the contents providing area group corresponding to the received contents providing area information is stored.

5. The contents providing apparatus of claim 1, further comprising:
a multicast address assigning unit assigning a multicast group address to the contents providing area group and setting a multicast group,
wherein the transmitting unit sets a multicast tree with respect to at least one cell of the multicast group and transmits the contents based on the multicast tree.

6. The contents providing apparatus of claim 5, wherein the transmitting unit requests the at least one cell of the multicast group to participate in the multicast group, and sets the multicast tree with respect to the at least one cell having participated in the multicast group according to the request.

7. A contents providing method based on a mobile communication network, the contents providing method comprising:
receiving contents and contents providing area information of the contents from a contents provider, the contents providing area information being information about an area where the contents is provided;
retrieving at least one cell based on the contents providing area information, and setting the retrieved at least one cell as a contents providing area group of the contents; and
transmitting the contents to the set contents providing area group.

8. The contents providing method of claim 7, wherein, when a contents providing area group corresponding to the received contents providing area information is stored, the setting sets the stored contents providing area group as a contents providing area group of the received contents.

9. The contents providing method of claim 7, further comprising:
assigning a multicast group address to the contents providing area group and setting a multicast group,
wherein the transmitting sets a multicast tree with respect to at least one cell of the multicast group and transmits the contents based on the multicast tree.

10. The contents providing method of claim 9, wherein the transmitting requests the at least one cell of the multicast group to participate in the multicast group, and sets the multicast tree with respect to the at least one cell having participated in the multicast group according to the request.
